(19) United States
(12) Patent Application Publication
(10) Pub. No.: US 2010/0265739 A1
(43) Pub. Date: Oct. 21, 2010

(54) LIGHT-DIFFUSING SHEET AND BACKLIGHT DEVICE USING SAME

(76) Inventors: Yohei Funabashi, Saitama (JP); Hiroyasu Ishikawa, Mie (JP); Kenji Fukui, Saitama (JP)

Correspondence Address: KENEALY VAIDYA LLP, 515 EAST BRADDOCK RD SUITE B, Alexandria, VA, 22314, US

(21) Appl. No.: 12/809,036

(22) PCT Filed: Jan. 22, 2009
(86) PCT No.: PCT/JP2009/050919

§ 371 Date: Jun. 17, 2010

(30) Foreign Application Priority Data
Jan. 24, 2008 (JP) 2008 013995

(51) Int. Cl. F21V 8/00; G02B 5/02; G09F 13/04

(52) U.S. Cl. 362/618; 359/599; 362/97.1

(57) ABSTRACT

A light-diffusing sheet which can prevent generation of scratches on the surface of the light-diffusing sheet or a surface of another member contacting with the light-diffusing sheet at the time of being used as a constituent member of a backlight unit of a liquid crystal display or transportation thereof, and also can exhibit the light-diffusing performance is provided. The light-diffusing sheet of the present invention has a light-diffusing layer comprising microparticles, wherein the light-diffusing layer has a surface showing a maximum peak height (Rp) of 8.0 μm or higher in a roughness curve determined by three-dimensional surface profilometry, and mean particle size (φ) of the microparticles contained in the light-diffusing layer and thickness (d) of the light-diffusing layer satisfy the relationship: φ/d≦0.7.

### TECHNICAL FIELD

The present invention relates to a light-diffusing sheet suitably used as a member constituting a backlight unit for used in a liquid crystal display or the like, and a backlight unit using the same.

### BACKGROUND ART

As light-diffusing sheets used for backlight units of liquid crystal displays etc., those comprising a support and a light-diffusing layer comprising a resin and microparticles and provided on one surface of the support have conventionally been used.

For such light-diffusing sheets, performances including ability to vanish light diffusion pattern of a light guide panel, high brightness for the frontal direction, and so forth are required.

In order to satisfy such desired performances, improvements have been made by changing types and contents of the resin and microparticles used for the light-diffusing layer. However, since it is considered that increase of brightness for the frontal direction obtainable by such improvements is limited, it is attempted to use a prism sheet to direct circumferentially spreading lights to the frontal direction. Since such a prism sheet does not have light-diffusing property, it has been proposed to use it together with a light-diffusing sheet superposed thereron (Patent documents 1 and 2). The conventional problems have been thereby overcome, that is, brightness for the frontal direction is improved compared with the case where only the conventional light-diffusing sheet is used, and moreover, sufficient light-diffusing property can be obtained.

Patent document 1: Japanese Patent Unexamined Publication (KOKAI) No. 9-127314 (claims)
Patent document 2: Japanese Patent Unexamined Publication No. 9-197109 (claims)

### DISCLOSURE OF THE INVENTION

### Aspect to be Achieved by the Invention

However, when a light-diffusing sheet and a prism sheet are piled up as described above, scratches may be generated on the surface of the light-diffusing sheet or the surface of the prism sheet contacting with the light-diffusing sheet. Further, when a plurality of such light-diffusing sheets are piled up and transported, scratches may also be similarly generated on the surfaces of the light-diffusing sheets. If scratches are generated as described above, even few scratches may cause defects in liquid crystal displays of higher definition becoming common in these days. Therefore, there arises a problem that, when it is attempted to constitute a backlight of a liquid crystal display by using such a light-diffusing sheet, extremely careful handling thereof is required, which invites poor productivity.

Therefore, an aspect of the present invention is to provide a light-diffusing sheet which can prevent generation of scratches on the surface of the light-diffusing sheet or a surface of another member contacting with the light-diffusing sheet at the time of being used as a constituent member of a backlight unit of a liquid crystal display or transportation thereof, and also can exhibit the conventionally required light-diffusing performances, and a backlight unit using such a light-diffusing sheet.

### Means for Achieving the Aspect

The inventor of the present invention conducted various researches concerning the aforementioned aspect, and as a result, found that scratches were generated on a surface of a light-diffusing sheet or a surface of a member contacting with the surface of the light-diffusing sheet by foreign matters such as dust particles existing between the sheets. Then, the inventor of the present invention further found that if the surface of the light-diffusing sheet was made to have a specific three-dimensional profile, and a ratio of the mean particle size of the microparticles and the thickness of the light diffusing layer was within a specific range, generation of scratches due to the presence of foreign matters could be prevented, while the light-diffusing property was maintained, and thus accomplished the present invention.

That is, the light-diffusing sheet of the present invention is a light-diffusing sheet having a light-diffusing layer comprising microparticles, wherein the light-diffusing layer has a surface showing a maximum peak height (Rp) of 8.0 μm or higher in a roughness curve determined by three-dimensional surface profilometry, and mean particle size (0) of the microparticles contained in the light-diffusing layer and thickness (d) of the light-diffusing layer satisfy the following relationship:

φ/d≦0.7.

In the light-diffusing sheet of the present invention, the surface of the light-diffusing layer preferably shows a maximum peak height (Rp) of 9.0 μm or higher in a roughness curve determined by three-dimensional surface profilometry.

In the light-diffusing sheet of the present invention, the mean particle size of the microparticles is preferably not smaller than 8 μm and not larger than 20 μm.

In the light-diffusing sheet of the present invention, the light diffusing layer may contain two or more kinds of microparticles having different mean particle sizes, and each of the mean particle sizes of the microparticles of the different types satisfies the relationship of φ/d≦0.7.

Further, the backlight unit of the present invention comprises a light guide panel having a light source at least at one end of the panel and a surface substantially perpendicular to the end as a light-projecting surface and a light-diffusing sheet disposed on the light-projecting surface of the light guide panel, wherein the light-diffusing sheet of the present invention is used as the light-diffusing sheet.

Alternatively, the backlight unit of the present invention comprises a light source, a light-diffusing plate disposed on one side of the light source, and a light-diffusing sheet disposed on the side of the light-diffusing plate opposite to the light source side, wherein the light-diffusing sheet of the present invention is used as the light-diffusing sheet.

The maximum peak height (Rp) in a roughness curve determined by three-dimensional surface profilometry for the surface of the light-diffusing layer of the light-diffusing sheet of the present invention is a value obtained from a three-dimensional roughness curve prepared by performing plotting for an area of 0.5 mm length and 1 mm width with pitches of 2 μm for the length direction and 1 μm for the width direction to obtain two-dimensional roughness curves according to the two-dimensional surface profilometry defined in JIS-B0601:1994, and integrating the two-dimensional roughness curves for the length direction and width direction.

### Effect of the Invention

Since the light-diffusing sheet of the present invention has a surface showing a maximum peak height (Rp) of 8.0 μm or higher in a roughness curve, the light-diffusing sheet contacts with another member via convexes having a relatively large height, and therefore even if foreign matters exist between the light-diffusing sheet and the other member, the foreign matters enter into the spaces between the convexes having a relatively large height, and do not damage the contacting surfaces of the both. Further, because the mean particle size φ of the microparticles contained in the light-diffusing layer and thickness d of the light-diffusing layer are determined to satisfy the relationship: φ/d≦0.7, appropriate concaves into which the foreign matters can enter can be formed between the convexes having a peak height of 8.0 μm or higher, and the light-diffusing sheet as a whole can exhibit high light-diffusing property.

The present invention is particularly effective for foreign matters such as dust particles having a size of about 20 μm or smaller.

In the backlight unit using the light-diffusing sheet of the present invention, scratches are not generated by foreign matters, and therefore image quality is not degraded.

### BRIEF DESCRIPTION OF THE DRAWINGS

FIG. 1 shows relationship between the light-diffusing layer of the light-diffusing sheet of the present invention and a foreign matter.

FIG. 2 shows relationship between a light-diffusing layer of another light-diffusing sheet and a foreign matter.

FIG. 3 shows relationship between a light-diffusing layer of yet another light-diffusing sheet and a foreign matter.

FIG. 4 shows an embodiment of the backlight unit of the present invention.

FIG. 5 shows another embodiment of the backlight unit of the present invention.

### DESCRIPTION OF NUMERICAL NOTATIONS

1 . . . Light diffusing layer
2 . . . Foreign matter
140 . . . Edge light type backlight unit
143 . . . Light-diffusing sheet
150 . . . Direct type backlight unit
153 . . . Light-diffusing sheet

### BEST MODE FOR CARRYING OUT THE INVENTION

Hereafter, embodiments of the light-diffusing sheet of the present invention will be explained.

The light-diffusing sheet of the present invention has a light-diffusing layer comprising microparticles, and it may consist of a single layer of the light-diffusing layer, or may comprise a support and the light-diffusing layer laminated on the support.

The light-diffusing layer basically consists of microparticles and a resin.

As the microparticles, inorganic microparticles such as those of silica, clay, talc, calcium carbonate, calcium sulfate, barium sulfate, aluminum silicate, titanium oxide, synthetic zeolite, alumina, and smectite, as well as organic microparticles such as those of styrene resin, urethane resin, benzoguanamine resin, silicone resin, and acrylic resin can be used. Among these, organic microparticles are preferably used for improving the performance concerning brightness, and organic microparticles consisting of an acrylic resin are particularly preferably used. Not only a single kind of particles, but also two or more kinds of particles can also be used in combination.

Although shape of the microparticles is not particularly limited, they are preferably spherical particles, which show superior light-diffusing property. Further, the microparticles preferably have a mean particle size of 1 to 40 μm for obtaining the uneven surface profile according to the present invention with good balance of light-diffusing property and brightness, and it is more preferably 1 to 20 μm for preventing glaring due to light transmission through the light-diffusing layer or reducing cost. The mean particle size is particularly preferably 8 to 20 μm for easily obtaining a maximum peak height (Rp) of 8.0 μm or higher.

As the microparticles, two or more kinds of microparticles of the same or different materials having different mean particle sizes may be used in combination.

Coefficient of variation for the particle size distribution of the microparticles is preferably about 15 to 55%, more preferably about 25 to 50%, for making it easier to obtain the desired maximum peak height described later. When the microparticles show such particle size distribution, the microparticles contain appropriate amounts of particles having a diameter larger than the mean particle size and particles having a diameter smaller than the mean particle size in an intermingled state. Therefore, the light-diffusing layer has a surface profile that there are interspersed relatively high convexes, and spaces showing relatively small differences of heights are easily formed between the convexes. With such a three-dimensional profile, both light-diffusing property and anti-scratching effect can be achieved simultaneously.

The mean particle size of the microparticles and the coefficient of variation for the particle size distribution referred to in the present invention are calculated by using values measured by the Coulter counter method. The Coulter counter method is a method for electrically measuring number and size of particles dispersed in a solution. If particles are dispersed in an electrolytic solution, and passed through electrified pores by suction, the electrolytic solution is replaced by the volume of the particles to increase the resistance, and voltage pulses are generated in proportion to the volume of the particles. In the Coulter counter method, heights and numbers of the voltage pulses are electrically measured to obtain particle number and individual particle volumes, and particle size and particle size distribution are calculated.

As the resin of the light-diffusing layer of the present invention, resins showing superior optical transparency can be used. There can be used, for example, thermoplastic resins, thermosetting resins, ionizing radiation hardening resins and so forth, such as polyester resins, acrylic resins, acrylic urethane resins, polyester acrylate resins, polyurethane acrylate resins, epoxy acrylate resins, urethane resins, epoxy resins, polycarbonate resins, cellulose resins, acetal resins, polyethylene resins, polystyrene resins, polyamide resins, polyimide resins, melamine resins, phenol resins, and silicone resins. Among these, acrylic resins showing superior weather resistance and optical characteristics are preferably used.

Content ratio of the microparticles to that of the resin in the light-diffusing layer of the present invention cannot generally be defined, since it may vary depending on the mean particle size of the microparticles to be used or thickness of the light-diffusing layer. However, for more easily obtaining the uneven profile according to the present invention with good balance of the performances of light-diffusing property and brightness, the microparticles are preferably used in an amount of 250 parts by weight or less, with respect to 100 parts by weight of the resin. Further, for preventing degradation of transparency due to difference of the refractive indexes of the resin and the microparticles and reducing cost, the microparticles are preferably used in an amount of 200 parts by weight or less, with respect to 100 parts by weight of the resin. Furthermore, for more easily obtaining the maximum peak height (Rp) of the present invention, the microparticles are preferably used in an amount of 90 to 210 parts by weight, more preferably 150 to 200 parts by weight, with respect to 100 parts by weight of the resin.

To the light-diffusing layer, besides the aforementioned resin and the microparticles, there may be added additives such as photopolymerization initiators, photopolymerization enhancers, surfactants such as leveling agents and antifoams, anti-oxidants and ultraviolet absorbers.

Thickness of the light-diffusing layer is determined by considering relationship to the mean particle size φ of the microparticles contained in the light-diffusing layer, handling property, transparency, and so forth.

Specifically, when the light-diffusing sheet of the present invention consists of a single layer of the light-diffusing layer, the thickness is preferably 10 to 500 μm, more preferably 10 to 250 μm. With a thickness of 10 μm or larger, sufficient coated film strength, and favorable handling property can be secured. With a thickness of 500 μm or smaller, favorable transparency of the light-diffusing layer can be secured. When the light-diffusing layer is formed on a support, the thickness is preferable 7 to 60 μm, more preferably 20 to 35 μm, for more easily obtaining the uneven profile of the light-diffusing layer surface with securing the light-diffusing property. The thickness of the light-diffusing layer means the thickness from the top of the convex of the uneven surface of the light-diffusing layer to the surface of the light-diffusing layer opposite to the uneven surface.

As for the relationship between the mean particle size of the microparticles and the thickness of the light-diffusing layer, they are chosen to satisfy φ/d≦0.7, more preferably φ/d≦0.6.

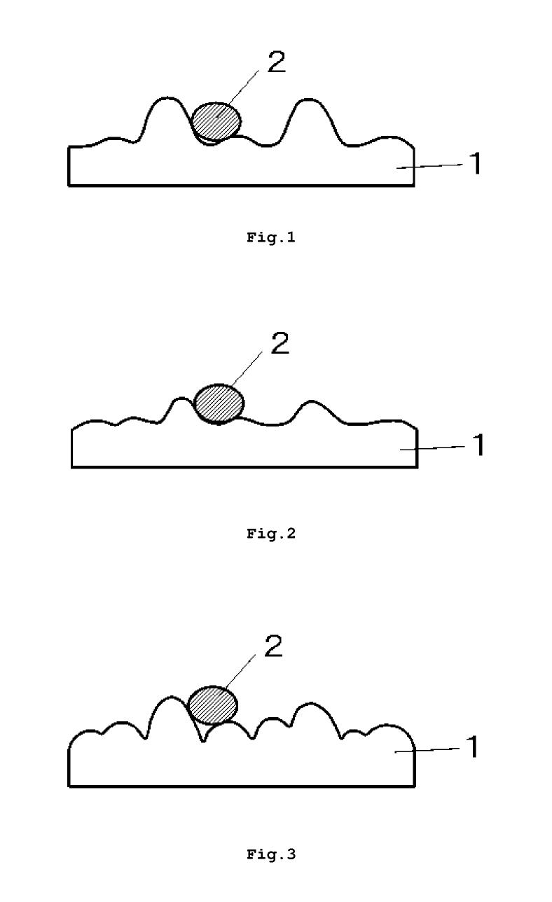

If the mean particle size of the microparticles and the thickness of the light-diffusing layer satisfy the relationship described above, and the light-diffusing layer has a surface showing a maximum peak height (Rp) of 8.0 μm or higher in a roughness curve determined in three-dimensional surface profilometry as described later, the surface of the light-diffusing layer 1 has a profile that relatively high convexes are interspersed on a relatively flat uneven profile, as shown in FIG. 1. On such a surface profile, even if a foreign matter 2 having a size of about 20 μm or smaller adheres to the surface of the light-diffusing layer 1, the height thereof does not exceed the height of the convex of the uneven profile, and it stays in the concave (FIG. 1). Even if two or more light-diffusing sheets of the present invention having foreign matters in such a state are piled up, or piled up with other members, the foreign matters contacts neither with the surfaces of the light-diffusing sheets, nor the surfaces of the members contacting with them. Therefore, according to the present invention, there is obtained a remarkable effect that, even if there are foreign matters between films, scratches are not generated on the surfaces of the light-diffusing sheets of the present invention or surfaces of members contacting with them.

In particular, if the condition of φ/d≦0.6 is satisfied, the light-diffusing layer surface has a flatter uneven profile, and therefore generation of scratches caused by rubbing of the sheets at the time of manufacture of the sheets and so forth, not caused by foreign matters as described above, can also be favorably prevented, while the anti-scratching property for scratches caused by foreign matters is also secured. Moreover, the light-diffusing sheet can be produced at a lower cost.

When two or more kinds of the microparticles are used, the aforementioned relationship is preferably satisfied by at least 90% of the microparticles, more preferably all the microparticles.

The light-diffusing layer of the light-diffusing sheet of the present invention has a surface showing a maximum peak height (Rp) of 8.0 μm or higher in a roughness curve determined by three-dimensional surface profilometry. If the light-diffusing layer surface of the light-diffusing sheet has such a specific three-dimensional profile, and the mean particle size of the microparticles and the thickness of the light-diffusing layer satisfy the aforementioned relationship, the light-diffusing sheet of the present invention exhibits the remarkable effect that, for all the light-diffusing property thereof, no scratch is generated on the surface of the light-diffusing sheet of the present invention or a surface of a member contacting with it.

On the other hand, if the mean particle size of the microparticles and the thickness of the light diffusing layer satisfy the aforementioned relationship, but the surface of the light-diffusing layer shows a maximum peak height (Rp) smaller than 8.0 μm in a roughness curve determined by three-dimensional surface profilometry, height of the convexes of the uneven profile becomes lower, and the height of the foreign matter 2 exceeds the height of the convex of the uneven profile (FIG. 2). In such a case, if two or more sheets of the light-diffusing sheets are piled up, or the light-diffusing sheet is piled up with another member, the foreign matter contacts with the surface of the light-diffusing sheet or the surface of the member contacting with it and generates scratches on the surface of the light-diffusing sheet or the surface of the member contacting with it.

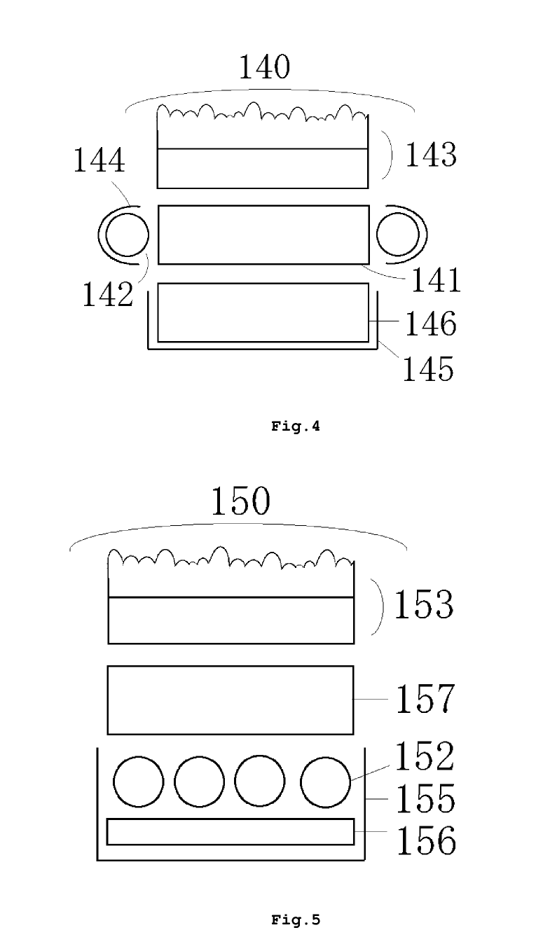

Further, if the surface of the light-diffusing layer of the light-diffusing sheet has such a specific three-dimensional surface profile, but the mean particle size of the microparticles and the thickness of the light diffusing layer do not satisfy the aforementioned relationship, shape of the microparticles more easily affects the surface profile of the light-diffusing layer 1, and variation of the height or depth of the uneven profile becomes more significant. Therefore, area of concave between the convexes may become smaller, or the depth of the concave may become smaller, thus it become more difficult for the foreign matter 2 to be included into the gap between the convexes, and the height of the foreign matter 2 exceeds the height of the convex of the uneven profile (FIG. 3). In such a case, if two or more sheets of the light-diffusing sheets are piled up, or the light-diffusing sheet is piled up with another member, the foreign matter contacts with the surface of the light-diffusing sheet or the surface of the member contacting with it and generates scratches on the surface of the light-diffusing sheet or the surface of the member contacting with it.

The aforementioned maximum peak height (Rp) in a roughness curve determined by three-dimensional surface profilometry is more preferably 9.0 μm or higher, still more preferably 10 μm or higher, for further preventing generation of scratches by foreign matters. As for the upper limit of the maximum peak height, it is preferably 30.0 μm or smaller for preventing falling-off of the particles and deformation of the convexes.

The maximum peak height on the surface of the light-diffusing layer can be realized by determining the mean particle size of the microparticles, the coefficient of variation for the particle distribution, the ratio of the resin and the microparticles in the light-diffusing layer, and the thickness of the light-diffusing layer to be within the afore-mentioned appropriate ranges.

The light-diffusing sheet of the present invention having a support will be explained below.

The material of the support is not particularly limited, so long as a material not degrading transparency is chosen. For example, there can be used transparent plastic films consisting of one kind of material or a mixture of two or more kinds of materials selected from polyester resins, acrylic resins, acrylic urethane resins, polyester acrylate resins, polyurethane acrylate resins, epoxy acrylate resins, urethane resins, epoxy resins, polycarbonate resins, cellulose resins, acetal resins, vinyl resins, polyethylene resins, polystyrene resins, polypropylene resins, polyamide resins, polyimide resins, melamine resins, phenol resins, silicone resins, fluorocarbon resins, cyclic polyolefin resins, and so forth.

Among these, a polyethylene terephthalate film subjected to a stretching process, especially a polyethylene terephthalate film subjected to a biaxial stretching process, is preferred, since such a film shows superior mechanical strength and dimensional stability. Further, in order to improve adhesion to the light-diffusing layer, a support of which surface is subjected to a corona discharge treatment, or a support provided with an easy adhesion layer is also preferably used.

Thickness of the support is usually preferably about 10 to 400 μm.

The surface of the light-diffusing sheet of the present invention opposite to the uneven surface may be subjected to a fine matting treatment in order to prevent adhesion with other members, or may be subjected to an anti-reflection treatment in order to improve light transmittance. Furthermore, a back coat layer, an antistatic layer or an adhesive layer may be provided on it by such coating and drying methods as described below.

The light-diffusing sheet of the present invention can be produced by coating a coating solution for light-diffusing layer prepared by dissolving or dispersing materials including the aforementioned resin and the microparticles in a suitable solvent on a support by a known conventional method, for example, bar coating, blade coating, spin coating, roll coating, gravure coating, curtain flow coating, die coating, spray coating, screen printing, and so forth, and drying it. When the light-diffusing sheet of the present invention consists of a single layer of the light-diffusing layer, it can be produced by extruding a mixture of the resin, the microparticles, and so forth from an extruder, or by forming a light-diffusing layer on a support as described above and removing the support by delamination.

When the light-diffusing sheet of the present invention explained above is incorporated as one part of, mainly, a backlight unit constituting a light source of a liquid crystal display, an illumination signboard, a lighting fixture, a scanner or a copying machine, it is suitably used without suffering from generation of scratches on the uneven surface of the light-diffusing sheet or a member contacting with it, even if foreign matters such as dust particles are contained. Further, even if two or more of the light-diffusing sheets of the present invention are piled up and transported, the light-diffusing sheets are not scratched by foreign matters, and therefore undue carefulness is not required for handling thereof.

Hereafter, embodiments of the backlight unit of the present invention provided with the light-diffusing sheet of the present invention will be explained.

The backlight unit of the present invention consists of at least the light-diffusing sheet of the present invention and a light source. Although the direction of the light-diffusing sheet in the backlight unit is not particularly limited, it is preferably used so that the uneven surface should serve as the light-projecting surface. Backlight units are classified into those of the edge light type and direct type depending on the disposition scheme of the light source, and the present invention can be applied to both the types.

A backlight unit of the edge light type consists of a light guide panel, a light source disposed along at least one end of the light guide panel, a light-diffusing sheet disposed on the light-projecting surface side of the light guide panel, and so forth. The light-diffusing sheet is preferably used so that the uneven surface should serve as the light-projecting surface. Further, a prism sheet is preferably used between the light guide panel and the light-diffusing sheet. With such a configuration, a backlight unit exhibiting superior balance of brightness for frontal direction and viewing angle can be provided.

The light guide panel has a substantially plate-like shape at least one of which sides serves as a light-entering surface and one of which surfaces perpendicular to the side serves as a light-projecting surface, and mainly consists of a matrix resin selected from highly transparent resins such as polymethyl methacrylate. Resin particles having a refractive index different from that of the matrix resin may be added as required. Each surface of the light guide panel may not be a uniform plane, but has a complicated surface profile, or may be subjected to diffusion printing for a dot pattern or the like.

The light source is disposed for at least one end of the light guide panel, and cold-cathode tube, LED light sources etc. are mainly used. Examples of the shape of the light source include a point shape, linear shape, L-shape, and so forth.

A backlight unit of the edge light type is provided with, besides the aforementioned light-diffusing sheet, light guide panel and light source, a light reflector, a polarization film, an electromagnetic wave shield film etc. depending on the purpose.

One embodiment of the backlight unit of the edge light type according to the present invention is shown in FIG. 4. This backlight unit 140 has a configuration that light sources 142 are provided on both sides of a light guide panel 141, and a light-diffusing sheet 143 is placed on the upside of the light guide panel 141 so that the surface having the convex pattern should be the surface opposite to the surface contacting with the light guide panel. The light sources 142 are covered with light source reflectors 144 except for the parts facing the light guide panel 141 so that lights from the light source should efficiently enter into the light guide panel 141. Moreover, a light reflector 146 stored in a chassis 145 is provided under the light guide panel 141. By this configuration, lights projected from the side of the light guide panel 141 opposite to the light-projecting side are returned into the light guide panel 141 again to increase lights projected from the projection surface of the light guide panel 141.

A backlight unit of the direct type consists of a light-diffusing sheet, a light-diffusing element and a light source disposed in this order on a surface of the light-diffusing sheet opposite to the light-projecting surface, and so forth. The light-diffusing sheet is preferably used so that the uneven surface should serve as the light-projecting surface. Moreover, a prism sheet is preferably used between the light-diffusing element and the light-diffusing sheet. With such a configuration, a backlight unit exhibiting superior balance of brightness for frontal direction and viewing angle can be provided.

The light-diffusing element is for erasing a pattern of the light source, and a milky resin plate, a transparent film on which a dot pattern is formed on a portion corresponding to the light source (lighting curtain) as well as a so-called light-diffusing film having an uneven light diffusing layer on a transparent substrate, and so forth can be used independently or in a suitable combination.

As the light source, those similar to those used for backlight units of the edge light type can be used. A backlight unit of the direct type may be provided with, besides the aforementioned light-diffusing sheet, light diffusing element and light source, a light reflector, a polarization film, an electromagnetic wave shield film, etc. depending on the purpose.

One embodiment of the backlight unit of the direct type according to the present invention is shown in FIG. 5. This backlight unit 150 has a configuration that two or more light sources 152 are provided above a light reflector 156 stored in a chassis 155, and a light-diffusing sheet 153 is placed thereon via a light-diffusing element 157 as shown in the drawing.

Because the backlight unit of the present invention utilizes the light-diffusing sheet of the present invention, in which scratches are not generated by foreign matters, as a light-diffusing sheet for diffusing lights projected from a light source or a light guide panel, it can provide favorable image quality.

### EXAMPLES

Hereafter, the present invention will be further explained with reference to examples. The term “part” and symbol “%” are used in weight basis, unless especially indicated.

### 1. Production of Light-Diffusing Sheets

### Example 1

Components of a coating solution for light-diffusing layer of the following composition were mixed, and the mixture was stirred, then applied to a support consisting of a polyethylene terephthalate film having a thickness of 100 μm (Lumirror T60, Toray Industries, Inc.) so as to obtain a dry thickness of 27 μm by the bar coating method, and dried to form an light-diffusing layer and thereby obtain a light-diffusing sheet of Example 1.

### <Coating Solution for Light-Diffusing Layer of Example 1>

| | |
|---|---|
| Acryl polyol | 110 parts |
| (ACRYDIC A-837, Dainippon Ink & Chemicals, Inc., | |
| solid content: 50%) | |
| Isocyanate type curing agent (Takenate D110N, | 22 parts |
| Mitsui Chemicals Polyurethane, Inc., | |
| solid content: 60%) | |
| Acrylic resin particles | 110 parts |
| (mean particle size: 15 μm, | |
| coefficient of variation: 35%) | |
| Butyl acetate | 200 parts |
| Methyl ethyl ketone | 200 parts |

### Example 2

A light-diffusing sheet of Example 2 was obtained in the same manner as that of Example 1, except that the coating solution for light-diffusing layer of Example 1 was changed to a coating solution for light-diffusing layer of the following composition, and the light-diffusing layer was designed so as to have a dry thickness of 29 μm.

### <Coating Solution for Light-Diffusing Layer of Example 2>

| | |
|---|---|
| Acryl polyol | 162 parts |
| (ACRYDIC 52-668, Dainippon Ink & Chemicals, Inc., | |
| solid content: 50%) | |
| Isocyanate type curing agent (Takenate D110N, | 32 parts |
| Mitsui Chemicals Polyurethane, Inc., | |
| solid content: 60%) | |
| Acrylic resin particles | 200 parts |
| (Techpolymer MBX-20, Sekisui Plastics Co., Ltd., | |
| mean particle size: 20 μm, | |
| coefficient of variation: 35%) | |
| Butyl acetate | 220 parts |
| Methyl ethyl ketone | 220 parts |

### Example 3

A light-diffusing sheet of Example 3 was obtained in the same manner as that of Example 2, except that the amount of the acrylic resin particles in the coating solution for light-diffusing layer of Example 2 was changed to 210 parts, and the light-diffusing layer was designed so as to have a dry thickness of 35 μm.

### Example 4

A light-diffusing sheet of Example 4 was obtained in the same manner as that of Example 1, except that the coating solution for light-diffusing layer of Example 1 was changed to a coating solution for light-diffusing layer of the following composition, and the light-diffusing layer was designed so as to have a dry thickness of 20 μm.

### <Coating Solution for Light-Diffusing Layer of Example 4>

| | |
|---|---|
| Acryl polyol | 231 parts |
| (ACRYDIC A-807, Dainippon Ink & Chemicals, Inc., | |
| solid content: 50%) | |
| Isocyanate type curing agent (Takenate D110N, | 45 parts |
| Mitsui Chemicals Polyurethane, Inc., | |
| solid content: 60%) | |
| Acrylic resin particles | 121 parts |
| (mean particle size: 10 μm, | |
| coefficient of variation: 35%) | |
| Silicone resin particles | 7.7 parts |
| (Tospearl 130, Momentive Performance | |
| Materials Inc., | |
| mean particle size: 3 μm) | |
| coefficient of variation: 10%) | |
| Butyl acetate | 230 parts |
| Methyl ethyl ketone | 230 parts |

### Comparative Example 1

A light-diffusing sheet of Comparative Example 1 was obtained in the same manner as that of Example 1, except that the coating solution for light-diffusing layer of Example 1 was changed to a coating solution for light-diffusing layer of the following composition, and the light-diffusing layer was designed so as to have a dry thickness of 11 μm.

### <Coating Solution for Light-Diffusing Layer of Comparative Example 1>

| | |
|---|---|
| Acryl polyol | 100 parts |
| (ACRYDIC A-807, Dainippon Ink & Chemicals, Inc., | |
| solid content: 50%) | |
| Isocyanate type curing agent (Takenate D110N, | 20 parts |
| Mitsui Chemicals Polyurethane, Inc., | |
| solid content: 60%) | |
| Acrylic resin particles | 100 parts |
| (mean particle size: 8 μm, | |
| coefficient of variation: 20%) | |
| Butyl acetate | 180 parts |
| Methyl ethyl ketone | 180 parts |

### Comparative Example 2

A light-diffusing sheet of Comparative Example 2 was obtained in the same manner as that of Comparative Example 1, except that the coating solution for light-diffusing layer of Comparative Example 1 was changed to a coating solution for light-diffusing layer of the following composition.

### <Coating Solution for Light-Diffusing Layer of Comparative Example 2>

| | |
|---|---|
| Acryl polyol | 162 parts |
| (ACRYDIC A-807, Dainippon Ink & Chemicals, Inc., | |
| solid content: 50%) | |
| Isocyanate type curing agent (Takenate D110N, | 32 parts |
| Mitsui Chemicals Polyurethane, Inc., | |
| solid content: 60%) | |
| Acrylic resin particles (Chemisnow MX-1000, | 55 parts |
| Soken Chemical & Engineering Co., Ltd., | |
| mean particle size: 10 μm, | |
| coefficient of variation: 10%) | |
| Silicone resin particles (Tospearl 130, | 15 parts |
| Momentive Performance Materials Inc., | |
| mean particle size: 3 μm, | |
| coefficient of variation: 10%) | |
| Butyl acetate | 215 parts |
| Methyl ethyl ketone | 215 parts |

### Comparative Example 3

A light-diffusing sheet of Comparative Example 3 was obtained in the same manner as that of Comparative Example 1, except that the coating solution for light-diffusing layer of Comparative Example 1 was changed to a coating solution for light-diffusing layer of the following composition.

### <Coating Solution for Light-Diffusing Layer of Comparative Example 3>

| | |
|---|---|
| Acryl polyol | 100 parts |
| (ACRYDIC A-807, Dainippon Ink & Chemicals, Inc., | |
| solid content: 50%) | |
| Isocyanate type curing agent (Takenate D110N, | 20 parts |
| Mitsui Chemicals Polyurethane, Inc., | |
| solid content: 60%) | |
| Acrylic resin particles | 100 parts |
| (Techpolymer MBX-8, Sekisui Plastics Co., Ltd., | |
| mean particle size: 7 μm, | |
| coefficient of variation: 40%) | |
| Butyl acetate | 180 parts |
| Methyl ethyl ketone | 180 parts |

### Comparative Example 4

A light-diffusing sheet of Comparative Example 4 was obtained in the same manner as that of Example 1, except that the coating solution for light-diffusing layer of Example 1 was changed to a coating solution for light-diffusing layer of the following composition, and the light-diffusing layer was designed so as to have a dry thickness of 23 μm.

### <Coating Solution for Light-Diffusing Layer of Comparative Example 4>

| | |
|---|---|
| Acryl polyol | 100 parts |
| (ACRYDIC A-807, Dainippon Ink & Chemicals, Inc., | |
| solid content: 50%) | |
| Isocyanate type curing agent (Takenate D110N, | 20 parts |
| Mitsui Chemicals Polyurethane, Inc., | |
| solid content: 60%) | |
| Acrylic resin particles | 12.5 parts |
| (mean particle size: 20 μm, | |
| coefficient of variation: 10%) | |
| Acrylic resin particles | 100 parts |
| (mean particle size: 8 μm, | |
| coefficient of variation: 20%) | |
| Butyl acetate | 180 parts |
| Methyl ethyl ketone | 180 parts |

### Comparative Example 5

A light-diffusing sheet of Comparative Example 5 was obtained in the same manner as that of Example 1, except that the coating solution for light-diffusing layer of Example 1 was changed to a coating solution for light-diffusing layer of the following composition, and the light-diffusing layer was designed so as to have a dry thickness of 25 μm.

### <Coating Solution for Light-Diffusing Layer of Comparative Example 5>

| | |
|---|---|
| Acryl polyol | 123 parts |
| (ACRYDIC A-817, Dainippon Ink & Chemicals, Inc., | |
| solid content: 50%) | |
| Acryl polyol | 123 parts |
| (ACRYDIC A-811, Dainippon Ink & Chemicals, Inc., | |
| solid content: 50%) | |
| Isocyanate type curing agent (Takenate D110N, | 45 parts |
| Mitsui Chemicals Polyurethane, Inc., | |
| solid content: 60%) | |
| Acrylic resin particles | 330 parts |
| (polymethyl methacrylate truly spherical particles, | |
| mean particle size: 20 μm, | |
| coefficient of variation: 22%) | |
| Butyl acetate | 425 parts |
| Methyl ethyl ketone | 285 parts |

### 2. Three-Dimensional Surface Profilometry of Light-Diffusing Layers of Light-Diffusing Sheets

Three-dimensional surface profilometry was performed for the surface profiles of the light-diffusing layers of the light-diffusing sheets produced in Examples 1 to 4 and Comparative Examples 1 to 5 at arbitrary ten points by using a contact finger type surface profiler (SAS-2010 SAU-II, MEISHIN KOKI Co., Ltd., tip radius: 5 μm, material: diamond, measurement force: 0.8 mN), and averages of maximum peak heights (Rp) in roughness curves were obtained for the ten points. The measurement results are shown in Table 1.

### 3. Evaluation of Light-Diffusing Sheets

### (1) Light-Diffusing Property

The light-diffusing sheets of Examples 1 to 4 and Comparative Examples 1 to 5 were each incorporated into a 13.3-inch edge-light type liquid crystal backlight unit (one straight lamp, thickness of light guide panel: 5 mm) so that the support thereof should face the light guide panel. Evaluation of light-diffusing property was conducted by visual inspection of ability of the light-diffusing sheets to vanish light-diffusing pattern of the light guide panel. When light-diffusing pattern of the light guide panel could not be observed, it is indicated with the symbol “◯”, and when light-diffusing pattern could be observed, it is indicated with the symbol “X”. The test results are shown in Table 1.

### (2) Anti-Scratch Property

One hundred sheets for each of the light-diffusing sheets of Examples 1 to 4 and Comparative Examples 1 to 5 were prepared, piled-up 100 sheets for each of the light-diffusing sheets of Examples 1 to 4 and Comparative Examples 1 to 5 were put into a polyethylene bag, and the bag was placed between two sheets of cardboard, wrapped with a laminated paper sheet, and packaged in a corrugated box. Then, the corrugated box was transported from Mie to Tokyo by a truck (distance: about 600 km, average speed: 80 km/hour), then reciprocally transported once between Tokyo and Taiwan by an airplane (flight time: about 3 hours), and further transported from Tokyo to Mie by a track (the same distance and average speed as those mentioned above). Thereafter, the uneven surfaces of the light-diffusing sheets of Examples 1 to 4 and Comparative Examples 1 to 5 and the smooth surfaces of the light-diffusing sheets having been contacting with the uneven surfaces were observed by visual inspection. When scratches on the surface were not conspicuous, it is indicated with the symbol “⊚”, when surface was slightly scratched, but scratches were substantially inconspicuous, it is indicated with the symbol “◯”, and when scratches were conspicuous, it is indicated with the symbol “X”. The test results are shown in Table 1.

TABLE 1

| | Maximum peak | | Light- | Anti- |
|---|---|---|---|---|
| | height (Rp) | | diffusing | scratch |
| | [μm] | φ/d | property | property |
| Example 1 | 10.32 | 0.56 | ◯ | ⊚ |
| Example 2 | 13.67 | 0.69 | ◯ | ⊚ |
| Example 3 | 10.86 | 0.57 | ◯ | ⊚ |
| Example 4 | 8.19 | 0.5 | ◯ | ◯ |
| | | 0.15 | | |
| Comparative | 3.69 | 0.73 | ◯ | X |
| Example 1 | | | | |
| Comparative | 3.85 | 0.91 | ◯ | X |
| Example 2 | | 0.27 | | |
| Comparative | 5.34 | 0.64 | ◯ | X |
| Example 3 | | | | |
| Comparative | 8.07 | 0.87 | ◯ | X |
| Example 4 | | 0.35 | | |
| Comparative | 10.52 | 0.8 | ◯ | X |
| Example 5 | | | | |

In Table 1, “φ/d” indicates the relationship of the mean particle size φ of the microparticles and thickness d of the light-diffusing layer. When two kinds of microparticles were used as in Example 4, Comparative Examples 2 and 4, relationships for the both are indicated.

As shown in Table 1, in the light-diffusing sheets of Examples 1 to 4, the uneven surfaces of the light-diffusing layers showed maximum peak heights (Rp) higher than 8.0 μm in roughness curves determined by three-dimensional surface profilometry, and the mean particle size φ of the microparticles contained in the light-diffusing layer and the thickness d of the light-diffusing layer satisfied the following relationship:

φ/d≦0.7

(in Example 4, all the particles satisfied the relationship). Therefore, scratches on the uneven surfaces of the light-diffusing sheets and the smooth surfaces of the light-diffusing sheets having been contacting with them were substantially inconspicuous as observed by visual inspection, while the light-diffusing sheets exhibited light-diffusing property.

In particular, in the light-diffusing sheets of Examples 1 to 3, the uneven surfaces of the light-diffusing layers showed maximum peak heights (Rp) higher than 9.0 μm in roughness curves, and therefore scratches generated by foreign matters were particularly inconspicuous as observed by visual inspection.

On the other hand, in the light-diffusing sheets of Comparative Examples 1 to 3, the uneven surfaces of the light-diffusing layers showed maximum peak heights (Rp) smaller than 8.0 μm in roughness curves determined by three-dimensional surface profilometry, and in the light-diffusing sheets of Comparative Examples 1, 2, 4 and 5, the mean particle size φ of the microparticles contained in the light-diffusing layer and the thickness d of the light-diffusing layer did not satisfy the following relationship:

φ/d≦0.7.

Therefore, scratches generated by foreign matters on the uneven surfaces of the light-diffusing sheets of Comparative Examples 1 to 5 and the smooth surfaces of the light-diffusing sheets having been contacting with them were conspicuous as observed by visual inspection, although these light-diffusing sheets exhibited light-diffusing property.

### 4. Production and Evaluation of Backlight Units

Then, the light-diffusing sheets of Examples 1 to 4 and Comparative Examples 1 to 5 were each incorporated into a 15-inch edge light type backlight unit (one cold-cathode tube was provided for each of upside and downside) to produce backlight units of Examples 1 to 4 and Comparative Examples 1 to 5.

Since the backlight units of Examples 1 to 4 incorporated with the light-diffusing sheets of Examples 1 to 4 utilized the light-diffusing sheets in which scratches are not generated by foreign matters on the uneven surfaces of the light-diffusing sheets and the smooth surfaces of the light-diffusing sheets contacting with them, they exhibited favorable image quality even after use for a long period of time.

On the other hand, since the backlight units of Comparative Examples 1 to 5 incorporated with the light-diffusing sheets of Comparative Examples 1 to 5 utilized the light-diffusing sheets in which scratches are generated by foreign matters on the uneven surfaces of the light-diffusing sheets and the smooth surfaces of the light-diffusing sheets contacting with them, image quality exhibited by them was degraded with time, even though they exhibited light-diffusing property.

1. A light-diffusing sheet having a light-diffusing layer comprising microparticles, wherein the light-diffusing layer has a surface showing a maximum peak height (Rp) of 8.0 μm or higher in a roughness curve determined by three-dimensional surface profilometry, and mean particle size (φ) of the microparticles contained in the light-diffusing layer and thickness (d) of the light-diffusing layer satisfy the relationship:
φ/d≦0.7.

2. The light-diffusing sheet according to claim 1, wherein the surface of the light-diffusing layer shows a maximum peak height (Rp) of 9.0 μm or higher in a roughness curve determined by three-dimensional surface profilometry.

3. The light-diffusing sheet according to claim 1, wherein the mean particle size of the microparticles is not smaller than 8 μm and not larger than 20 μm.

4. The light-diffusing sheet according to claim 1, wherein the light-diffusing layer contains two or more kinds of microparticles having different mean particle sizes, and each of the mean particle sizes of the microparticles of the different types satisfies the relationship:
φ/d≦0.7.

5. A backlight unit comprising a light guide panel having a light source at least at one end of the panel and a surface substantially perpendicular to the end as a light-projecting surface and a light-diffusing sheet disposed on the light-projecting surface of the light guide panel, wherein the light-diffusing sheet according to claim 1 is used as the light-diffusing sheet.

6. A backlight unit comprising a light source, a light-diffusing plate disposed on one side of the light source, and a light-diffusing sheet disposed on the side of the light-diffusing plate opposite to the light source side, wherein the light-diffusing sheet according to claim 1 is used as the light-diffusing sheet.

7. The light-diffusing sheet according to claim 2, wherein the mean particle size of the microparticles is not smaller than 8 μm and not larger than 20 μm.

8. The light-diffusing sheet according to claim 2, wherein the light-diffusing layer contains two or more kinds of microparticles having different mean particle sizes, and each of the mean particle sizes of the microparticles of the different types satisfies the relationship:
φ/d≦0.7.

9. The light-diffusing sheet according to claim 3, wherein the light-diffusing layer contains two or more kinds of microparticles having different mean particle sizes, and each of the mean particle sizes of the microparticles of the different types satisfies the relationship:
φ/d≦0.7.

10. A backlight unit comprising a light guide panel having a light source at least at one end of the panel and a surface substantially perpendicular to the end as a light-projecting surface and a light-diffusing sheet disposed on the light-projecting surface of the light guide panel, wherein the light-diffusing sheet according to claim 2 is used as the light-diffusing sheet.

11. A backlight unit comprising a light guide panel having a light source at least at one end of the panel and a surface substantially perpendicular to the end as a light-projecting surface and a light-diffusing sheet disposed on the light-projecting surface of the light guide panel, wherein the light-diffusing sheet according to claim 3 is used as the light-diffusing sheet.

12. A backlight unit comprising a light guide panel having a light source at least at one end of the panel and a surface substantially perpendicular to the end as a light-projecting surface and a light-diffusing sheet disposed on the light-projecting surface of the light guide panel, wherein the light-diffusing sheet according to claim 4 is used as the light-diffusing sheet.

13. A backlight unit comprising a light source, a light-diffusing plate disposed on one side of the light source, and a light-diffusing sheet disposed on the side of the light-diffusing plate opposite to the light source side, wherein the light-diffusing sheet according to claim 2 is used as the light-diffusing sheet.

14. A backlight unit comprising a light source, a light-diffusing plate disposed on one side of the light source, and a light-diffusing sheet disposed on the side of the light-diffusing plate opposite to the light source side, wherein the light-diffusing sheet according to claim 3 is used as the light-diffusing sheet.

15. A backlight unit comprising a light source, a light-diffusing plate disposed on one side of the light source, and a light-diffusing sheet disposed on the side of the light-diffusing plate opposite to the light source side, wherein the light-diffusing sheet according to claim 4 is used as the light-diffusing sheet.
